(19) United States
(12) Patent Application Publication
(10) Pub. No.: US 2014/0330650 A1
(43) Pub. Date: Nov. 6, 2014

(54) SETTING COMPUTING DEVICE FUNCTIONALITY BASED ON TOUCH-EVENT PROPERTIES

(71) Applicants: Amit V. Karmarkar, Palo Alto, CA (US); Richard R. Peters, Mill Valley, CA (US); Sharada Kalanidhi Karmarkar, Palo Alto, CA (US)

(72) Inventors: Amit V. Karmarkar, Palo Alto, CA (US); Richard R. Peters, Mill Valley, CA (US); Sharada Kalanidhi Karmarkar, Palo Alto, CA (US)

(21) Appl. No.: 13/887,320

(22) Filed: May 4, 2013

(51) Int. Cl. G06Q 30/02

(52) U.S. Cl. CPC G06Q 30/0269
USPC 705/14.66

(57) ABSTRACT

In one example, a computer-implemented method can include the step of receiving a finger-contact patch attribute from a user of a touch screen system. A user's age group can be determined according to a finger-contact patch attribute. The user's age group can be provided to a server. A pixel width of the finger-contact patch of less than thirty pixels can be measured. A historical mean finger-contact patch area of a historical user of the touch screen system can be calculated. The finger-contact patch attribute from the user can be determined to be substantially less than the historical mean finger-contact patch area of the historical user. An advertisement to display on a computing device of the touch-screen system can be received. An appropriate age group appropriate of the advertisement can be determined. The advertisement can be filtered when a current user is in the child-age group and the appropriate age group appropriate of the advertisement is an adult age group.

### CROSS-REFERENCE TO RELATED APPLICATIONS

This application claims priority to U.S. patent provisional application no. 61/648,890 titled METHOD AND SYSTEM OF PROVIDING AGE-GROUP BASED ADVERTISEMENTS filed on May 18, 2012. This application claims priority to U.S. patent provisional application no. 61/643,049 titled METHOD AND SYSTEM OF SETTING DEVICE STATE ACCORDING TO USER AGE AS DETERMINED BY FINGER CONTACT PATCH ATTRIBUTES filed on May 4, 2012. This application claims priority to U.S. patent provisional application no. 61/656,999 titled METHOD AND SYSTEM FOR GENERATING A CHILD-SAFETY ALERT WITH A MOBILE DEVICE filed on Jun. 7, 2012. This application claims priority to U.S. patent provisional application no. 61/704,516 titled SETTING COMPUTING DEVICE FUNCTIONALITY BASED ON TOUCH-EVENT PROPERTIES filed on Sep. 23, 2012. These provisional applications are hereby incorporated by reference in their entirety.

### BACKGROUND OF THE INVENTION

1. Field

This application relates generally touch-screen systems, and more particularly to a system and method of setting computing-device functionality based on touch-event properties.

2. Related Art

There currently exist many types of input devices for performing operations with an electronic system. These operations often correspond to moving a cursor and/or making selections on a display screen. Illustrative electronic systems include tablet, notebook, desktop and server computer systems, personal digital assistants, audio and video control systems, digital billboards and kiosks, portable music and video players and mobile and satellite telephones. The use of touch pad and touch screen systems (collectively “touch-surfaces”) has become increasingly popular in these types of electronic systems because of their ease of use and versatility of operation. One particular type of touch-surface is the touch screen. Touch screens typically include a touch panel, a controller and a software driver. The touch panel is characteristically an optically clear panel with a touch sensitive surface that is positioned in front of a display screen so that the touch sensitive surface is coextensive with a specified portion of the display screen's viewable area (often, the entire display area). The touch panel registers touch events and sends signals indicative of these events to the controller. The controller processes these signals and sends the resulting data to the software driver. The software driver, in turn, translates the resulting data into events recognizable by the electronic system (e.g., finger movements and selections, contact patches modeled as ellipses, fingerprint images).

Unlike earlier input devices, touch-surfaces are now capable of simultaneously detecting multiple objects as they approach and/or contact the touch-surface. Some can detect object shapes in much more detail (e.g. finger contact-patch values and/or fingerprint attributes). Examples of touch surfaces include, inter alia: a multi-touch screen, finger-print scanner, touch screen with a capacitance sensor and/or optical sensor (e.g. an infrared sensor) sufficient to obtain an image of a fingerprint and/or measure a finger contact-patch area, devices with sensors integrated in the pixels that can recognize objects placed on the display such as Microsoft's Second-generation Surface (e.g. uses PixelSense technology), and the like.

Furthermore, conventional methods of controlling child access to various types of content may involve such methods as: content filters, which limit access to age appropriate content, usage controls, which constrain the usage of these devices such as placing time-limits on usage or forbidding certain types of usage, computer usage management tools, which allow parents to enforce learning time into child computing time, and monitoring, which can track location and activity when using the devices. Such methods may be time consuming, tedious, and repetitive for an adult user of a computing device that implements them. For example, the adult user may have to disable parental controls in order to access certain websites and then reactivate them afterwards. In view of this, improvements may be made over conventional methods if, for example, a computing system were able to biometrically obtain a current user's age and implement parental controls accordingly.

### BRIEF SUMMARY OF THE INVENTION

In one embodiment, a computer-implemented method can include the step of receiving a finger-contact patch attribute from a user of a touch screen system. A user's age group can be determined according to a finger-contact patch attribute. The user's age group can be provided to a server.

Optionally, a pixel width of the finger-contact patch of less than thirty pixels can be measured. The user's age group can be determined to be a child age group. A historical mean finger-contact patch area of a historical user of the touch screen system can be calculated. The finger-contact patch attribute from the user can be determined to be substantially less than the historical mean finger-contact patch area of the historical user. The user's age group can be determined to be a child age group. An advertisement to display on a computing device of the touch-screen system can be received. An appropriate age group appropriate of the advertisement can be determined. The advertisement can be filtered when a current user is in the child-age group and the appropriate age group appropriate of the advertisement is an adult age group.

In another exemplary embodiment, a computer-implemented method includes receiving a user's age group information from a user's computing device. The user's age group information was determined according to a finger-contact patch attribute. The user's age group information is matched with an age-appropriate advertisement. The age-appropriate advertisement is communicated to the user's computing device.

### BRIEF DESCRIPTION OF THE DRAWINGS

The present application can be best understood by reference to the following description taken in conjunction with the accompanying figures, in which like parts may be referred to by like numerals.

FIG. 1 depicts a process of setting computing device functionality based on touch-event properties, according to some embodiments.

FIG. 2 depicts a contact patch of a child's touch on a touchscreen of a mobile device, according to some embodiments.

FIG. 3 depicts an example notification that can be sent when a child's touch is detected on the touch screen of mobile device, according to some embodiments.

FIG. 4 depicts an example display of a list of available application programs in mobile device that may be blocked, according to some embodiments.

FIG. 5 depicts an example display of a mobile device shutting down in the event that a child user has been detected, according to some embodiments.

FIG. 6 depicts an exemplary computing system that can be configured to perform any one of the processes provided herein.

FIG. 7 depicts a system of providing advertisements based on age-group data of a current user of a computing device, according to some embodiments.

FIG. 8 depicts an architecture block diagram of a computing device with a touch-screen system, according to some embodiments.

FIG. 9 illustrates a block diagram of an example advertisement management server, according some embodiments.

FIG. 10 depicts a flow diagram of an example process of providing a current user's age category to an advertiser, according to some embodiments.

FIG. 11 depicts a flow diagram of an example process of determining an age category of a user from finger contact-patch attributes, according to some embodiments.

FIG. 12 depicts a flow diagram of an example process of providing age-based advertisements to a user according to a user's age as derived from touch screen data, according to some embodiments.

The Figures described above are a representative set, and are not an exhaustive with respect to embodying the invention.

### DETAILED DESCRIPTION

Disclosed are a system, method, and article of manufacture of setting computing device functionality based on touch-event properties. Although the present embodiments included have been described with reference to specific example embodiments, it can be evident that various modifications and changes may be made to these embodiments without departing from the broader spirit and scope of the particular example embodiment.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### EXEMPLARY PROCESSES

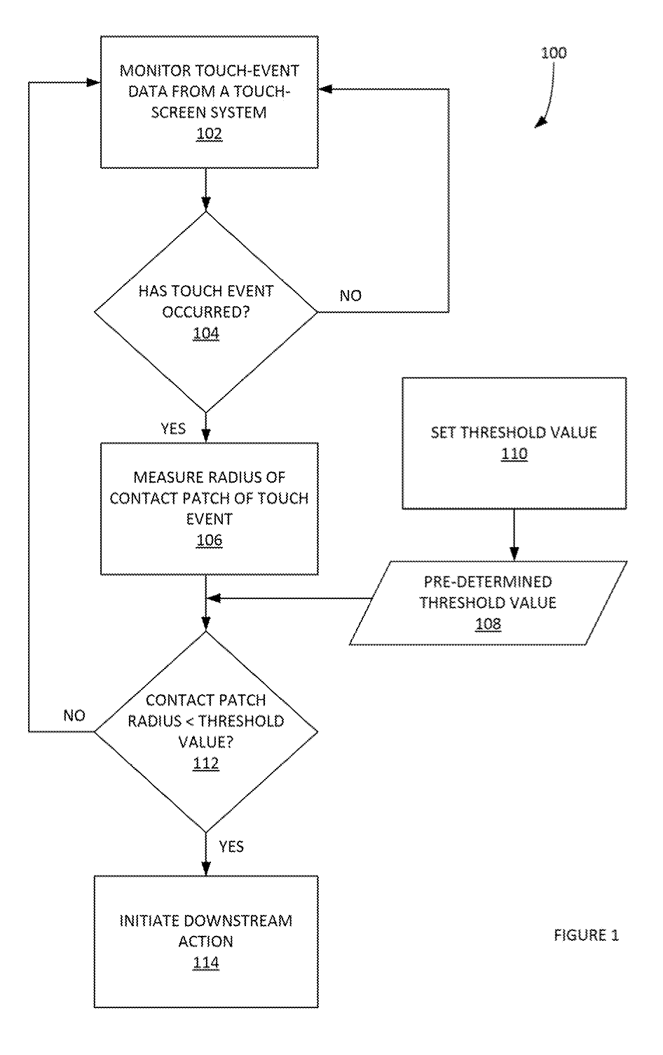

FIG. 1 depicts, in flow diagram format, a process 100 of setting computing device functionality based on touch-event properties, according to some embodiments. In step 102 of process 100, touch-event data from a touchscreen system is monitored. In step 104, it is determined if a touch event has occurred. This information may be stored in the system as a Boolean value. If a touch event has not occurred, then process 100 returns to step 102. Alternatively, the properties of the touch event are accessed when it is determined that a touch event has occurred. In particular, the radius (e.g. major radius and/or minor radius) of the touch event's contact patch is measured in step 106. A pre-determined threshold radius value 108 (e.g. reflecting the average radius for an age-category) is obtained. It is noted that the threshold radius value can be preset in step 110. In one example, a system administrator (e.g. a parent, a teacher, and the like) may set the threshold radius value. In another example, the threshold value may be a default value. A threshold radius value may be based on average contact-patch dimensions for age-based categories. For example, the threshold radius value may be 0.15 of an inch for young children. The threshold radius value may be stored and modified as desired by the user.

In step 110, it is determined if the measured contact-patch radius is less than the threshold radius value. If ‘no’, then process 100 returns to step 102. If ‘yes’, then a downstream action (e.g. downstream control of device functionality, notifications and the like) is initiated in step 114.

Several examples of downstream actions are now described. In one example, the action may include providing notifications to a designated user. For example, process 100 may be set to determine a child user of the touch-screen device. A notification may be provided (e.g. in the form of a text message, email, etc.) to a parent when a child-user is detected. In another example of downstream actions, system administrative functions native to the mobile device can be invoked. These functions can be capable of initiating and shutting down applications/tasks by accessing system-level info (e.g. thread ID, process ID, process name). One way to implement can be to access a list of existing installed applications and then determine the active application(s) running on the foreground (UI) thread. If user-saved preferences indicate that active application(s) should be shutdown by user, a message can be sent to system administration functions to shutdown the application upon the biometric detection of kid's touch. A shutdown application can occur substantially soon thereafter and the child can experience an “unresponsive touchscreen.”

In another example, system level control preferences may be obtained from a system administrator. For example, specified application programs (e.g. text messaging, games, and cell phone calls) may be blocked. For example, the computer system may be polled to determine all of the installed or native applications and/or programs on the devices. In one example, a user interface object such as a scrolling list of applications/programs may be provided to the system administrator. Additionally, a user interface object such as a checkbox may be provided to the system administrator to indicate the applications/programs that may be turned off upon the detection of a child. The system administrator may also indicate if some other application/program (e.g. a screen lock, system shutdown process, notification and the like) may be activated upon the detection of a child. A control object/mechanism may be provided for the system administrator to save the above indications in the form of saved settings. These indications may be updated as new programs are installed on the device. For this purpose, device level information may be accessed regarding the installation of new programs. A security object/mechanism may be provided for the system administrator to password-protect any selections and/or settings.

System level control preferences can then be executed once a child has been detected through analysis of a touch event. For example, access to the indicated application programs may be blocked and/or shutdown. In one embodiment, the saved list of application programs to be shutdown can be accessed. Information relating to the last state of the application programs can be saved. Instructions can be sent to the indicated application programs. Optionally, an instruction to start some other application program (e.g. as indicated by the system administrator) may be communicated to the relevant application programs. The system administrator may be informed when the application programs have been shutdown/blocked.

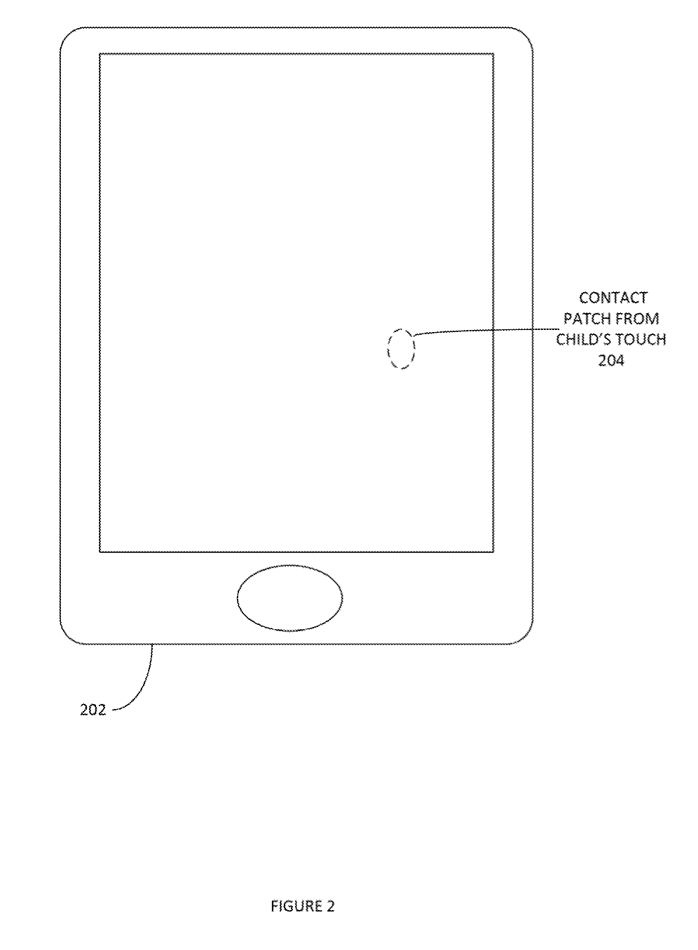

FIG. 2 depicts a contact patch 204 of a child's touch on a touchscreen of mobile device 202, according to some embodiments. The dimensions of the contact patch may be measured and compared to threshold values. For example, a major and/or minor radius of the contact patch may be measured.

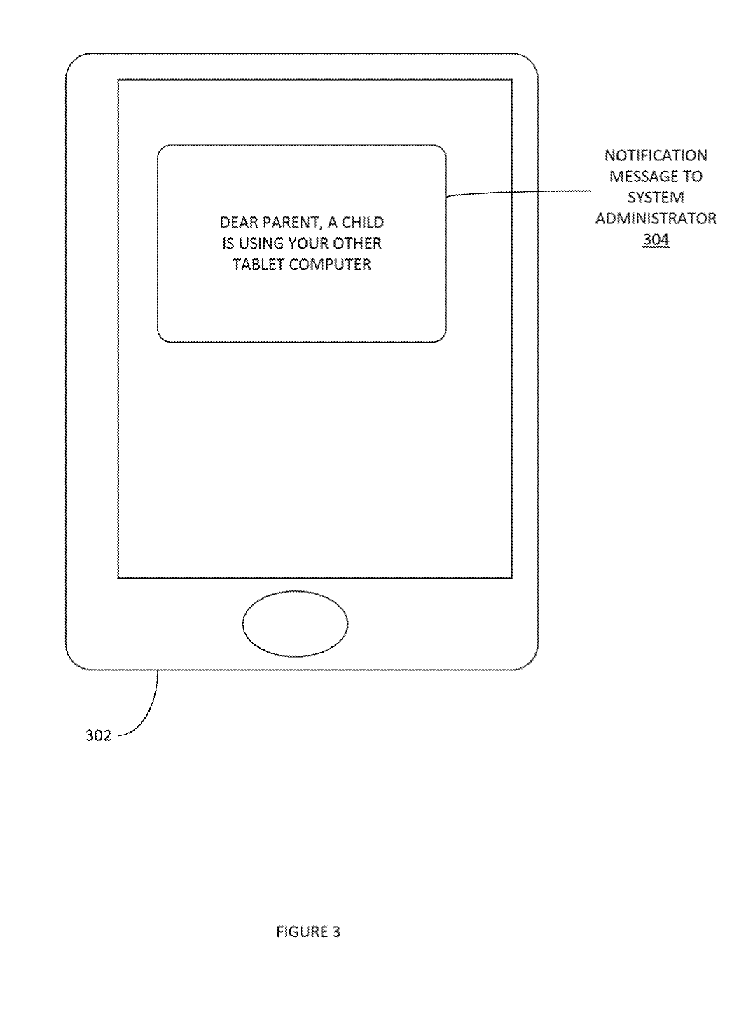

FIG. 3 depicts an example notification 304 that can be sent when a child's touch is detected on the touch screen of mobile device 802, according to some embodiments. Mobile device 802 can include a process to communicate notification 304 to a system administrator's device when a child touch event is detected. Optionally, notification 304 can also be displayed with mobile device 802 as well.

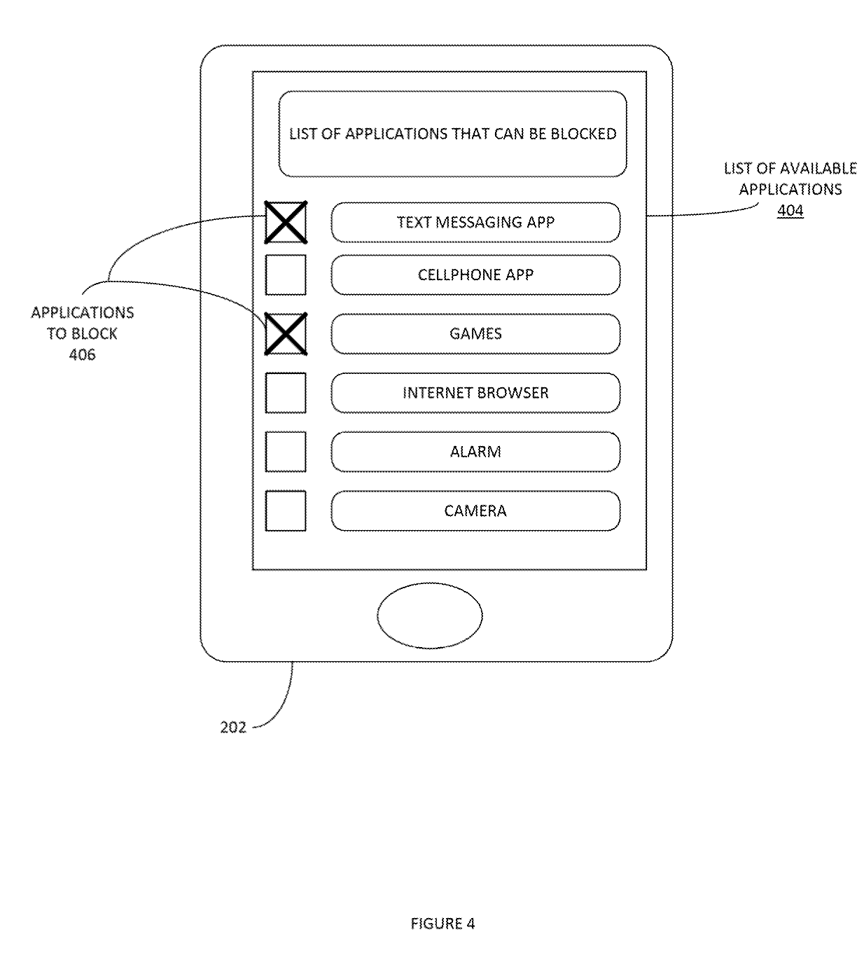

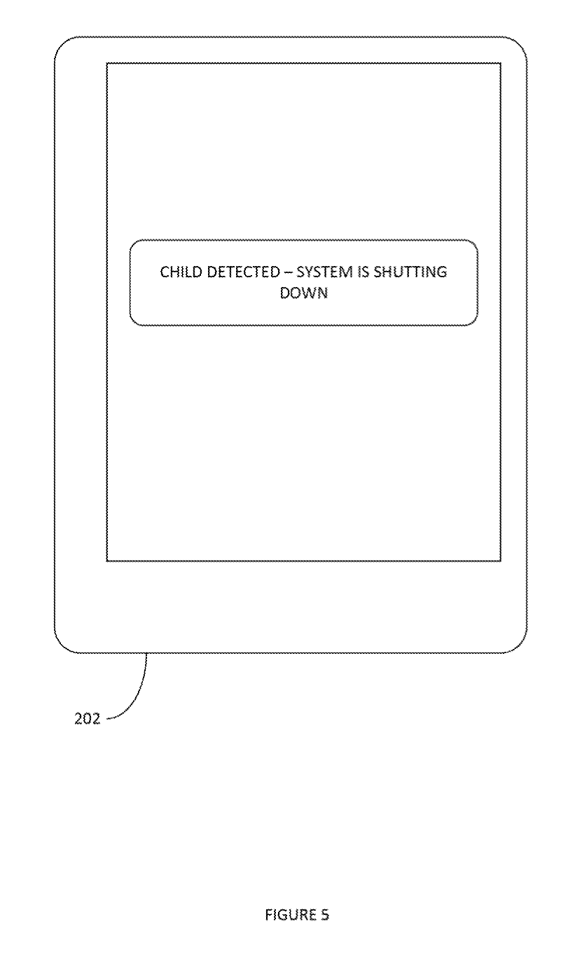

FIG. 4 depicts an example display of a list of available application programs 404 in mobile device 802 that may be blocked, according to some embodiments. Mobile device 802 can include a process to poll the operating system and generate list 404. Access to the list may be password protected. A system administrator (e.g. a parent) may indicate the application programs to be blocked (e.g. shutdown) in the event a child's touch event is detected. In one example, the system administrator may select to have the operating system of mobile device 202 enter a shutdown (e.g. as depicted in FIG. 5) and/or sleep state in the event a child's touch event is detected. A system administrator may also select to have a display screen lock implemented in the event a child's touch event is detected. They system may request the system administrator's password before the operating system is reset and/or individual application programs are once again accessible. Notifications may inform a current user of the various security implementations begin implemented when a child's touch event is detected.

Examplary Systems and Architecture

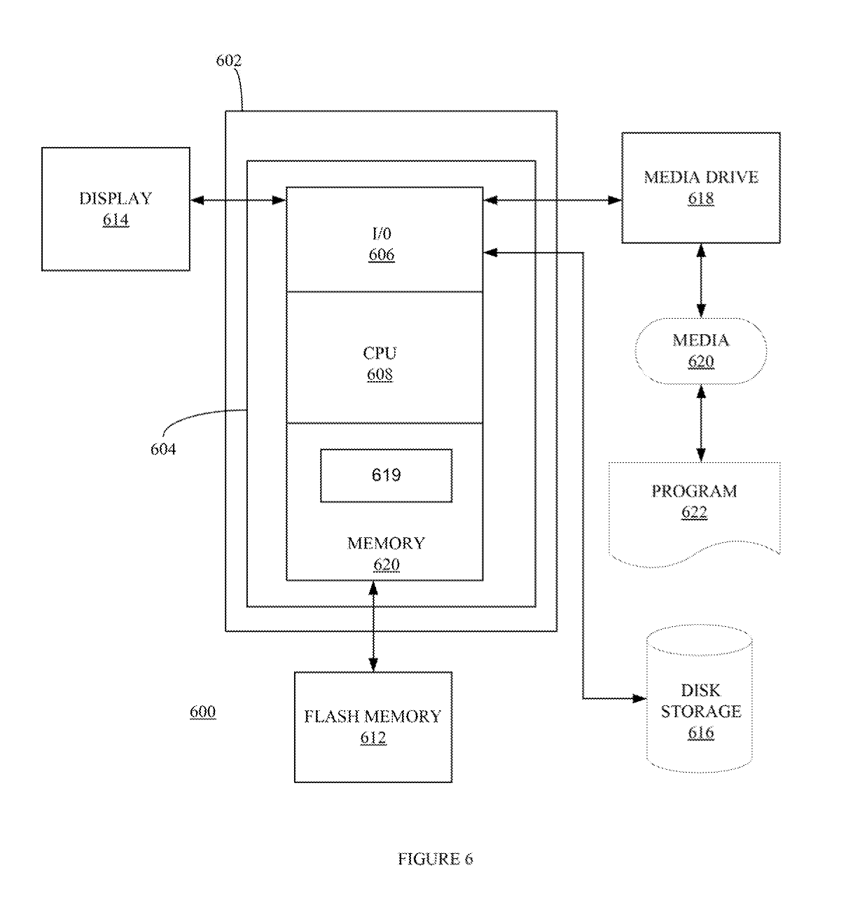

FIG. 6 depicts an exemplary computing system 600 that can be configured to perform any one of the processes provided herein. In this context, computing system 600 can include, for example, a processor, memory, storage, and I/O devices (e.g., monitor, keyboard, disk drive, Internet connection, etc.). However, computing system 600 can include circuitry or other specialized hardware for carrying out some or all aspects of the processes. In some operational settings, computing system 600 can be configured as a system that includes one or more units, each of which is configured to carry out some aspects of the processes either in software, hardware, or some combination thereof.

FIG. 6 depicts a computing system 600 with a number of components that can be used to perform any of the processes described herein. The main system 602 includes a motherboard 604 having an I/O section 606, one or more central processing units (CPU) 608, and a memory section 610, which can have a flash memory card 612 related to it. The I/O section 606 can be connected to a display 614, a keyboard and/or other attendee input (not shown), a disk storage unit 616, and a media drive unit 618. The media drive unit 618 can read/write a computer-readable medium 620, which can include memory 622 with programs and/or data. Computing system 600 can include a web browser. Moreover, it is noted that computing system 600 can be configured to include additional systems in order to fulfill various functionalities. Display 614 can include a touch-screen system and/or sensors for obtaining contact-patch attributes from a touch event. In some embodiments, system 600 can be included and/or be utilized by the various processes, systems and/or methods described herein. Process 619 may be include functionalities for implementing process 100 as well as the methods/processes provided in FIGS. 1-5.

Additional Processes and Use Cases

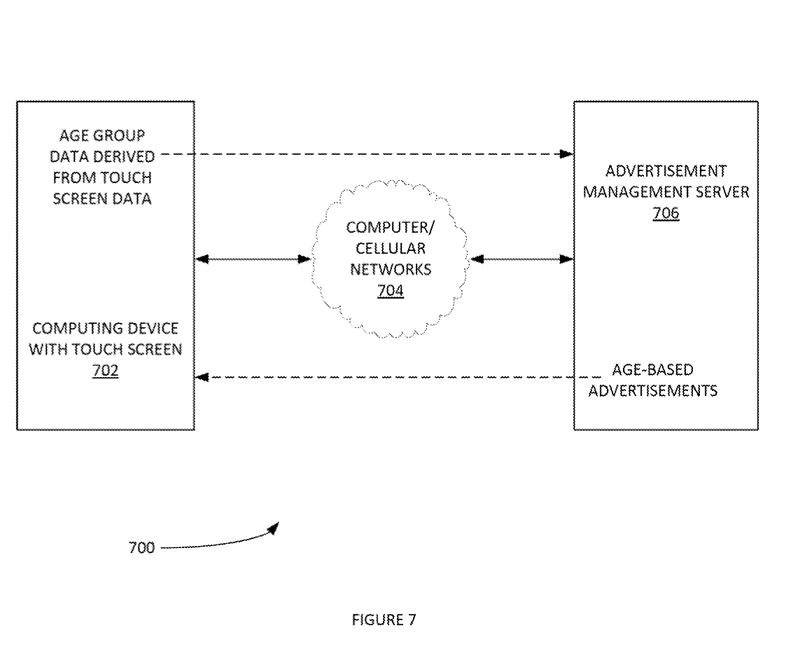

FIG. 7 depicts a system 700 of providing advertisements based on age-group data of a current user of a computing device 702, according to some embodiments. System 700 can include a computing device 702 (e.g. a mobile device such as a tablet computer, smart phone, lap top and the like that includes a touch-screen input system).

Computing device 702 can obtain a user's finger contact-patch attributes from the touch-screen system. Computing device 702 can determine a user's age group from the finger contact-patch attributes. Computing device 702 can communicate said age-group information to advertisement management server 704. Computing device 702 can include a plurality of applications (not shown) such as text messaging, augmented reality, instant messaging, photo-sharing applications, video-sharing applications, web browsers, email applications, etc. Computing device 702 can provide information regarding application-use history to advertisement management server 706 as well. For example, computing device 702 can communicate user age-group information and user current use of a text-messaging application to advertisement management server 704.

Advertisement management server 706 can obtain an age-appropriate advertisement and communicate it to computing device 702. Advertisement management server 706 can format the advertisement according to an appropriate standard for the particular type of computing device. For example, if the user is substantially currently using a text-messaging application, advertisement management server 706 can provide the advertisement to the user as a text message. In another example, if the user is substantially currently using an augmented-reality application, advertisement management server 106 can provide the advertisement to the user in an appropriate augmented-reality format. Advertisement management server 706 can obtain advertisements from third-party entities (not shown).

Computing/cellular networks 704 can include any communication networks that allow a computing device to communicate with a server (e.g. an IP network, mobile telecommunication services—3G, 4G, etc.) on the Internet.

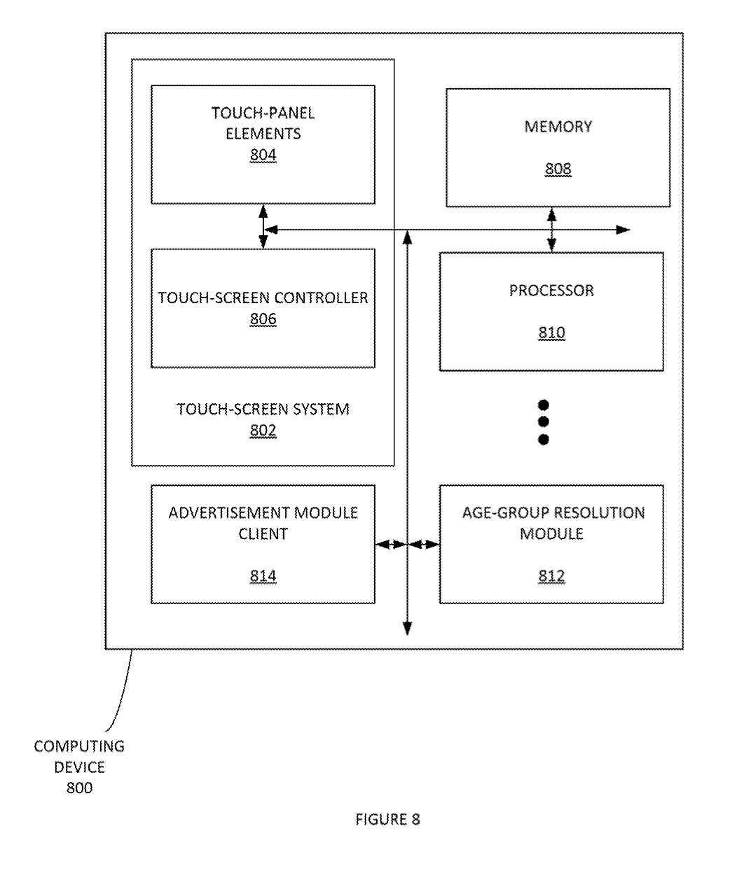

FIG. 8 depicts an architecture block diagram of a computing device 800 with a touch-screen system 802, according to some embodiments. Touch-screen system 802 can include hardware and/or software components that detect the presence and location of a touch within the display area. Touch-screen system 802 can include touch-panel elements 804 and touch-screen controllers 806. Touch-panel elements 804 can include various components such as LEDs, screen, sensors (e.g. capacitive sensors, optical sensors resistive sensors, surface acoustic wave sensors, etc.) according to the type of touch screen. Touch-screen controllers 806 to manage and obtain information from the touch-panel elements 804. Touch-screen controllers 806 can provide such information to memory and processor 810. Touch-screen controllers 806 can include hardware and/or software systems. Touch-screen controllers 806 can also utilized touch-panel elements data to calculate various geometric attributes of a contact event (e.g. finger contact-patch attributes, hand-pad contact-patch attributes, etc.). An age-group resolution module 812 can determine an age-group of a user with information from touch-screen controllers 806. Age-group resolution module 812 can provide the user age group to advertisement module client 814. Advertisement module client 814 can communicate user age group information as well as other information about the state of computing device 800 (e.g. open applications, web browsing history, and the like). Advertisement module client 814 can receive advertisements from an external advertisement management entity (e.g. advertisement management server 706 of FIG. 7) and manage the presentations of the advertisements in computing device 800.

One example of an implementation of the system of FIG. 8 is provided as follows. An object is placed on the display of touch-panel elements 804. An infrared backlight in touch-panel elements 804 illuminates the object (through the optical sheets, LCD and protection glass). Light reflected back from the object is registered by the sensors integrated in the pixels. Touch-screen controllers 806 obtain the values reported from all of the sensors and provide them to other modules of device 800. The values are used to create a picture of what is on the display. The picture is analyzed using image processing techniques creating a corrected image. The corrected sensor image and information about the objects placed on the display are sent to the processor 810 and/or age-group resolution module 812. Age-group resolution module 812 can compare the values to known anthropomorphic averages and determine an age group of the user.

Exemplary touch surfaces include, inter alia, a multi-touch screen, finger-print scanner, touch screen with a capacitance sensor and/or optical sensor (an e.g. infrared sensor) sufficient to obtain an image of a fingerprint and/or measure a finger contact-patch area, devices with sensors integrated in the pixels that can recognize objects placed on the display such as Microsoft's Second-generation Surface (e.g. uses PixelSense technology), and the like.

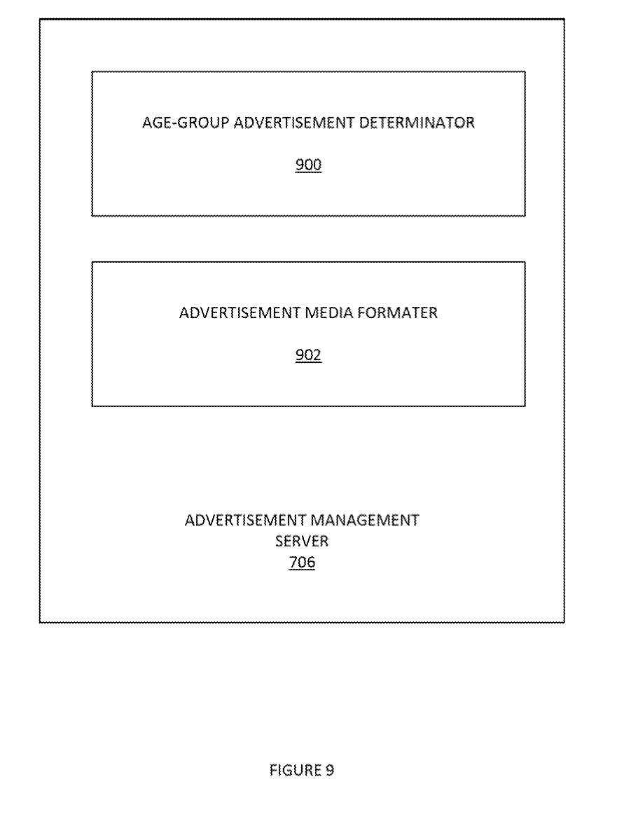

FIG. 9 illustrates a block diagram of an example advertisement management server, according some embodiments. Advertisement management server 706 can include one or more hardware and/or software modules for selecting and formatting an advertisement according to a current user's age group and/or an application in use on the user's computing device that can be used to display the advertisement. For example, advertisement management server 706 can be communicatively coupled with an IP network and receive information from a client application operating in a client-side computing device. The client application can provide advertisement management server 706 with current user age-group information as obtained from such methodologies as analysis of information about a user obtained by a touch screen system. The client application can also provide advertisement management server 706 with information about the client-side application used to display the advertisement. Advertisement management server 706 can include an age-group advertisement determinator module 900. Age-group advertisement determinator module 900 can determine an advertisement based on the user age-group information. Advertisement management server 706 can include an age-group advertisement media formatter module 902. Advertisement media formatter module 902 can format an advertisement to an appropriate media format and/or request an advertisement in an appropriate media format for display by the client-side application. Advertisement management server 706 can then provide the advertisement to the client-side device.

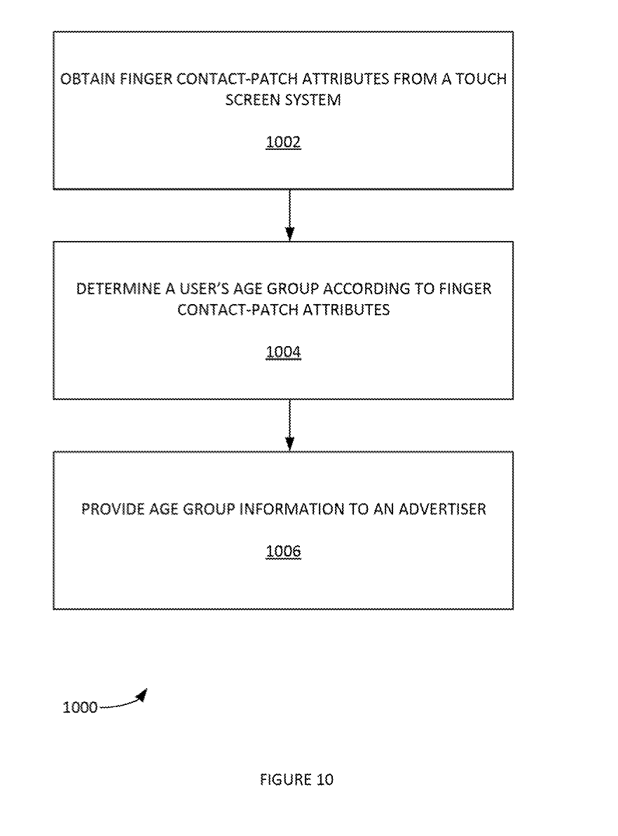

FIG. 10 depicts a flow diagram of an example process 1000 of providing a current user's age category to an advertiser, according to some embodiments. In step 1002, a finger contact-patch attribute is obtained from a touch-screen system (e.g. touch-screen system 802). Contact-patch attributes are obtained and measured. Example attributes can include the area of the contact patch as well as other values such as: the X radius of the ellipse that most closely circumscribes the area of contact with the screen, the Y radius of the ellipse that most closely circumscribes the area of contact with the screen, the rotation angle, in degrees, of the contact area ellipse defined by X radius and Y radius. The rotational angle value may be between zero (0) and ninety (90) degrees. Together, these three values can describe an ellipse that approximates the size and shape of the area of contact (i.e. contact patch) between the finger and the screen. In one embodiment, these values can be obtained utilizing a protocol such as the W3C Touch Events specification. The Touch Events specification defines a set of low-level events that represent one or more points of contact with a touch-sensitive surface, and changes of those points with respect to the surface and any DOM elements displayed upon it (e.g. for touch screens) or associated with it (e.g. for drawing tablets without displays). It is noted that all values can be converted from metric distance to pixels. For example, the anthropomorphic average width of the index finger and the thumb for adult men are 18.2 mm and 22.9 mm, respectively, and women 15.5 mm and 19.1 mm. Thus, in one example, the adult male average width of the index finger can then be converted to 45-57 pixels. This data can be stored in a local and/or remote database. In other example embodiments, other contact-patch types such as by a hand pad, side of a hand, side of a finger, can also be obtained. Other contact-patch attributes that can be utilized include average pressure of a user's touch, average speed of sliding motions of a user's touch, fingerprint attributes, etc.

In step 1004, a user's age group can be determined according to finger contact-patch attributes. For example, various anthropomorphic averages can be utilized to determine an age group of the user. A user's contact-patch attributes can be compared with known anthropomorphic averages of various age groups. A specified number of matches between the two sets can indicate a current user's age. In one example, a deviation from an adult average of a specified value (e.g. half the anthropomorphic average width of the index finger) can be used to determine a child user.

In step 1006, the age-group information is provided to an advertiser such as advertisement management server 706. Additional information, such as the type of application that was active when the contact-patch information was obtained can be provided. Moreover, location information, other sensor data (e.g. from other biometric sensors) can also be obtained and provided to the advertiser.

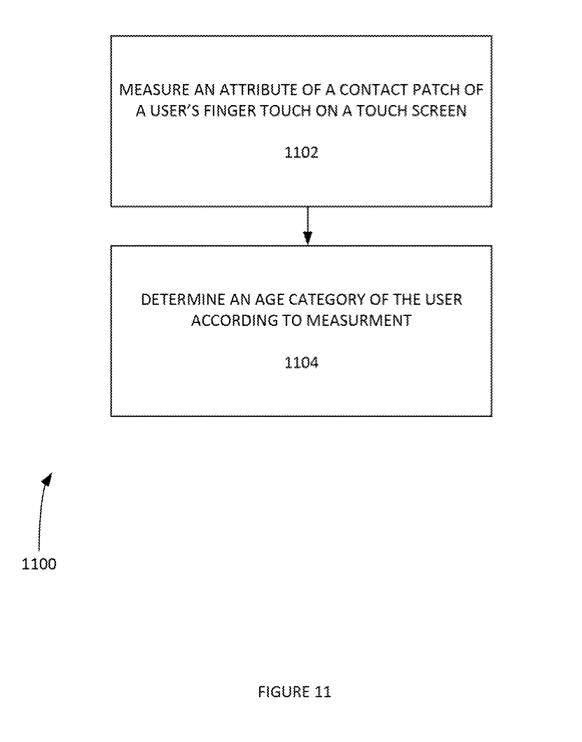

FIG. 11 depicts a flow diagram of an example process 1100 of determining an age category of a user from finger contact-patch attributes, according to some embodiments. The contact patch can be obtained from a user's finger touch on a touch screen of a computing device. In one example, the touch screen can be a multi-touch screen (e.g. in a tablet computer or smart phone), fingerprint scanner, touch screen with a capacitance sensor and/or optical sensor sufficient to obtain an image of a fingerprint and/or measure a finger contact-patch area, Microsoft's Second-generation Surface, and the like. When a user touches the screen, the area of contact area can be measured as an ellipse. This contact patch can vary in size and shape based on which finger is touching the screen, the size of the finger, the pressure of the finger on the screen, the orientation of the finger, and other factors. The size of the finger can vary according to age. The underlying multi-touch system in the computing device can provide contact-patch size information. Various techniques for determining a user's various contact patch parameters are described in further detail below.

In another example, other attributes of the finger contact patch can be obtained depending on the touch screen type. For example, if the touch screen includes a capacitance sensor of sufficient resolution, an image of the fingerprint can be obtained. Thus, fingerprint attributes can be utilized to determine the age category of the user. For example, epidermal ridge breadth attributes of a fingerprint can provide user age information.

In step 1104, an age category can be determined based on the measurement of the user's finger touch-contact attribute. A plurality of techniques can be utilized based on the various measurements of the finger touch contact that can be obtained. For example, finger contact-patch size can be used to estimate age (e.g. the various geometric values of an ellipse measured by a touch screen can be correlated to known anthropomorphic averages). The finger contact-patch size can be modified based on such factors as touch pressure, average finger contact-patch size over a number of touches and/or period of time, querying the user for a control finger contact-patch size, finger contact-patch size values associated with repeatable and identifiable operations (e.g. the typing of search engine query input, the typing of text messages, etc.) and the like. As noted above, epidermal ridge breadth attributes of a fingerprint can provide user age information as well.

In one example of process 1100, an average finger contact-patch area of a first user can be measured for a period of time. The average finger contact-patch area can be a general average of all finger touches and/or an average finger contact-patch area associated with a specific user activity such as inputting data into a search engine, typing a text message, activating an application by pressing an icon, etc. Later, a sharp decrease in the average finger contact-patch area can be detected. This decrease can be of a sufficient magnitude to indicate a transition from an adult user to a child user. Accordingly, the age category of the new user can be set to ‘child user’.

In another example of process 1100, a user can be prompted (e.g. when logging in, when creating a user profile, etc.) to press a finger (e.g. index finger, thumb, etc.) flatly against the touch screen. A contact-patch area profile of the adult user (as well as other adult users) can be maintained. Periodically and/or upon certain events (e.g. initializing a web browser application, a mobile phone application, etc.) the system can request a current user to press a finger flatly against the touch screen. For example, a user may want to open a web browser application. The system can request that the user flatly press an index finger against a multi-touch screen. The user's contact-patch area (e.g. modeled as a 2-D ellipse) can be measured and compared to known anthropomorphic averages and an age group of the user determined.

In other examples, user's contact-patch area can be measured while the user it utilizing the touchscreen for other types of input (e.g. while typing on a virtual keyboard, navigating a web page, etc.). In these examples, the known anthropomorphic averages can be based on a similar and/or same type of activity (e.g. an anthropomorphic average for typing on a virtual key-board with virtual buttons of a substantially similar size).

The range of the age category can vary depending on the type of parameters available. It is further noted that two or more techniques for determining an age category of a user can be integrated. Additionally, in some example embodiments, other biometric data can also be utilized to determine an age category. Moreover, various techniques can be utilized to differentiate contact areas sensed by the touch screen that are caused by other objects such as pads of a hand, the side of a hand, a stylus, etc. Furthermore, in some embodiments, the pressure of the object against the touch screen can be estimated and factored into the calculation of the finger contact-patch size. For example, the finger contact-patch size can be increased by a specified value if a light pressure is detected. The value of increase can be related to the pressure value.

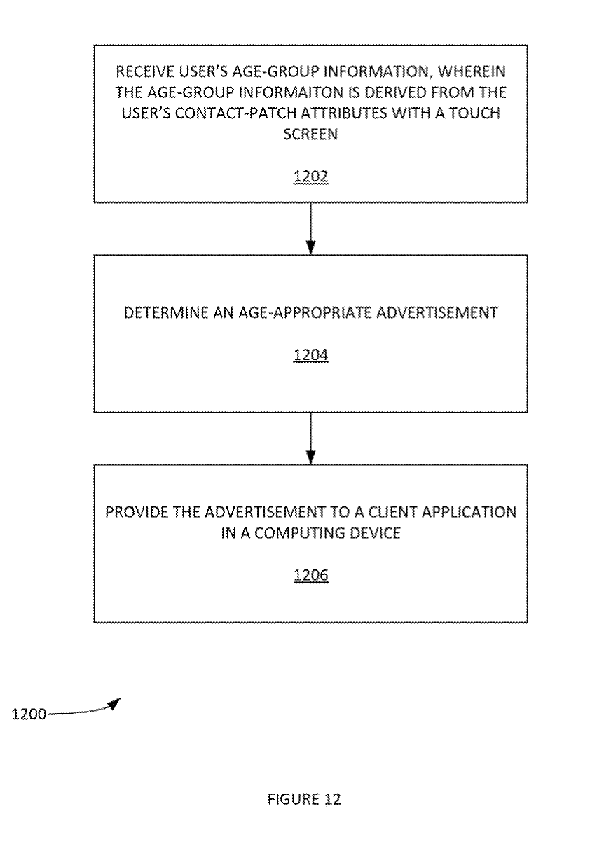

FIG. 12 depicts a flow diagram of an example process 1200 of providing age-based advertisements to a user according to a user's age as derived from touch screen data, according to some embodiments. In step 1202, a user's age-group information is received. Examples of age group information can include broad categories such as ‘young child’ or ‘not young child’, year ranges such as ‘5-10 years of age’, estimates of a user's age such as ‘probably an adult if a female user’, comparisons with other historical users of a computing device such as ‘current user is younger than normal user’, etc. Age groups can be determined based on comparisons of a user's touch-screen data (such as contact-patch attributes) with known averages and/or comparisons with other users of a particular computing device (e.g. a current user's contact-patch area is less than an average contact-patch area as measured over a specified period by a specified amount can be used to determine a child as a current user).

In step 1204, an age-appropriate advertisement is determined. For example, an advertiser can maintain a list of advertisements matched with various age groups. In step 1206, the age-appropriate advertisement is provided to a client application in the computing device that provided the user's age-group information. It is noted that, in some embodiments, the advertiser can also use information about a client-side application to format the advertisement. For example, the advertisement can be formatted according to a type of device (e.g. a video protocol for viewing an advertisement video on a mobile device, an augmented-reality protocol, etc.). Steps 1204 and 1206 can be performed algorithmically by server-side utilities accessible via a computer/cellular network.

In one example of determining an age-group of a current user of a touch-screen device a historical mean finger-contact patch area of a historical user of the touch screen system can be calculated. For example, each finger-contact patch area can be measured and stored. These measurements can be divided by the number of finger contacts. The finger contacts can be for fixed number of most recent finger contacts (e.g. last one-hundred (100) finger contacts, last twenty (20) finger contacts, finger contacts for last week, etc.). The finger-contact patch attribute from the current user can be determined to be substantially less than the historical mean finger-contact patch area of the historical user. This can occur when the historical user is an adult user and a toddler becomes the current user. Accordingly, the current user's age group to be set to the child age group. An advertisement to display on a computing device (e.g. a tablet computer) with the touch-screen system can be received. In another example, a video can be received (e.g. a YouTube® video). An age-group appropriate for the advertisement and/or video can be determined (e.g. using a metadata tag in the advertisement file). If the current user in the child-age group, the advertisement and/or video can be blocked/filtered from being displayed on the computing device.

At least some values based on the results of the above-described processes can be saved for subsequent use. Additionally, a computer-readable medium can be used to store (e.g., tangibly embody) one or more computer programs for performing any one of the above-described processes by means of a computer. The computer program may be written, for example, in a general-purpose programming language (e.g., Pascal, C, C++, Java, Python) and/or some specialized application-specific language (PHP, Java Script, XML).

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium. Finally, acts in accordance with FIGS. 1-12 may be performed by a programmable control device executing instructions organized into one or more program modules. A programmable control device may be a single computer processor, a special purpose processor (e.g., a digital signal processor, “DSP”), a plurality of processors coupled by a communications link or a custom designed state machine. Custom designed state machines may be embodied in a hardware device such as an integrated circuit including, but not limited to, application specific integrated circuits (“ASICs”) or field programmable gate array (“FPGAs”). Storage devices suitable for tangibly embodying program instructions include, but are not limited to: magnetic disks (fixed, floppy, and removable) and tape; optical media such as CD-ROMs and digital video disks (“DVDs”); and semiconductor memory devices such as Electrically Programmable Read-Only Memory (“EPROM”), Electrically Erasable Programmable Read-Only Memory (“EEPROM”), Programmable Gate Arrays and flash devices.

What is claimed as new and desired to be protected by Letters Patent of the United States is:

1. A computer-implemented method comprising:
receiving a finger-contact patch attribute from a user of a touch screen system;
determining, with at least one processor, a user's age group according to a finger-contact patch attribute; and
providing the user's age group to a server.

2. The computer-implemented method of claim 1, wherein the step of determining a user's age group according to the finger-contact patch attribute further comprises:
measuring a pixel width of the finger-contact patch of less than twenty pixels; and
determining the user's age group to be a child age group.

3. The computer-implemented method of claim 1, wherein the step of determining a user's age group according to the finger-contact patch attribute further comprises:
measuring a pixel width of the finger-contact patch greater than fifty pixels; and
determining the user's age group to be an adult-male age group.

4. The computer-implemented method of claim 1, wherein the step of determining a user's age group according to the finger-contact patch attribute further comprises:
calculating a historical mean finger-contact patch area of a historical user of the touch screen system;
determining the finger-contact patch attribute from the user to be substantially less than the historical mean finger-contact patch area of the historical user; and
determining the user's age group to be a child age group.

5. The computer-implemented method of claim 4 further comprising:
receiving an advertisement to display on a computing device of the touch-screen system; and
determining an appropriate age group appropriate of the advertisement.

6. The computer-implemented method of claim 5 further comprising:
filtering the advertisement when a current user is in the child-age group and the appropriate age group appropriate of the advertisement is an adult age group.

7. A computer-implemented method comprising:
receiving a user's age group information from a user's computing device, wherein the user's age group information was determined according to a finger-contact patch attribute;
matching the user's age group information with an age-appropriate advertisement; and
communicating the age-appropriate advertisement to the user's computing device.

8. The computer-implemented method of claim 7, wherein the user's age group information comprises a child user's age group information.

9. The computer-implemented method of claim 8, wherein the finger-contact patch attribute comprises a pixel width of the finger-contact patch of less than twenty pixels.

10. The computer-implemented method of claim 8, wherein the finger-contact patch attribute comprises a mean pixel width of a specified number of a set of last measured finger-contact patches, and wherein the mean pixel width is less than eight millimeters.

11. The computer-implemented method of claim 7, wherein the finger-contact patch comprises an anthropomorphic average finger-contact patch attribute for the child user's age group information.

12. The computer-implemented method of claim 7, wherein other contact-patch types are used to determine the user's age group information based on anthropomorphic age-group averages.

13. The computer-implemented method of claim 12, wherein the other contact-patch types comprise a hand-pad measurement, aside-of-a-hand pad measures or a side-of-a-finger measurement.

14. A computer system for providing age-appropriate media content to a computing system with a touch screen, the system comprising:
memory configured to store an instruction for providing an age-appropriate media content; and
one or more processors configured to:
receive a user's age group information from a user's computing device, wherein the user's age group information was determined according to a finger-contact patch attribute;
match the user's age group information with an age-appropriate advertisement; and
communicate the age-appropriate advertisement to the user's computing device.

15. The computer-implemented method of claim 14, wherein the user's age group information comprises a child user's age group information.

16. The computer-implemented method of claim 15, wherein the finger-contact patch attribute comprises a pixel width of the finger-contact patch of less than twenty pixels.

17. The computer-implemented method of claim 15, wherein the finger-contact patch attribute comprises a mean pixel width of a specified number of a set of last measured finger-contact patches, and wherein the mean pixel width is less than eight millimeters.

18. The computer-implemented method of claim 14, wherein the finger-contact patch comprises an anthropomorphic average finger-contact patch attribute for the child user's age group information.

19. The computer-implemented method of claim 14, wherein other contact-patch types are used to determine the user's age group information based on anthropomorphic age-group averages.

20. The computer-implemented method of claim 119, wherein the other contact-patch types comprise a hand-pad measurement, aside-of-a-hand pad measures or a side-of-a-finger measurement.
